(19) United States
(12) Patent Application Publication
(10) Pub. No.: US 2026/0159457 A1
(43) Pub. Date: Jun. 11, 2026

(54) ECO-FRIENDLY AND EDIBLE FIRE STARTER

(71) Applicant: Quentin Carson, APO, AE (US)

(72) Inventor: Quentin Carson, APO, AE (US)

(21) Appl. No.: 19/413,890

(22) Filed: Dec. 9, 2025

Related U.S. Application Data
(60) Provisional application No. 63/729,554, filed on Dec. 9, 2024.

(51) Int. Cl. C06C 9/00; A23L 19/00; C10L 5/44; F23Q 2/18

(52) U.S. Cl. CPC C06C 9/00; A23L 19/03; C10L 5/44; F23Q 2/18

(57) ABSTRACT

An eco-friendly fire starter system is disclosed, including a first container and a second container, the second container being configured to be removably stored within an interior of the first container. At least two combustible materials are used to catalyze a chemical reaction to combust the first container and the second container. One or more edible materials are stored within one of the first container or the second container.

### CROSS-REFERENCE TO RELATED APPLICATIONS

The present application claims priority to U.S. Provisional Patent Application 63/729,554 filed on Dec. 9, 2024, entitled “ECO-FRIENDLY AND EDIBLE FIRE STARTER” the entire disclosure of which is incorporated by reference herein.

### TECHNICAL FIELD

The embodiments disclosed herein generally relate to fire starters and more specifically to eco-friendly and edible fire starters.

### BACKGROUND

Fire is an essential tool for human survival and is critical for providing warmth as well as preparing food. Fire making is the process of artificially starting a fire. The process requires completing the fire triangle of fuel, an oxidizing agent, and heat which triggers combustion. The fuel source may vary and can include natural tinder but may also include chemicals commonly used in fire starting compositions. Chemicals such as potassium permanganate and glycerin are commonly used. However, these chemicals result in short ignition periods, require kenneling, and cannot be used in wet conditions. Further, potassium permanganate and glycerin are inedible and are not safe for use when lighting fires used to heat and cook food.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an eco-friendly fire starter system that includes a first container and a second container configured to be removably stored within an interior of the first container. The fire starter system is designed to ignite without the need for an external flame source and to provide a reliable method of producing a sustained flame in both indoor and outdoor uses. The structure of the system allows the first container to protect and house multiple components that are arranged for accessibility and safety. The second container is positioned inside the first container, so the components remain organized until activation is desired. This configuration enables users to store and transport the system efficiently while maintaining its readiness for use.

In some embodiments, the eco-friendly fire starter system includes one or more edible materials stored within the first container or the second container. The edible materials may include dehydrated citrus, a seed, a vegetable, or other plant-based food items suitable for consumption in emergencies. These edible materials may also contribute to combustion when combined with other materials during activation. The edible materials may offer nutritional value, including calories, antioxidants, and vitamins, which may support survival situations. Their inclusion enhances the multifunctional nature of the fire starter system.

The eco-friendly fire starter system further includes at least two combustible materials used to catalyze a chemical reaction sufficient to combust the first container and the second container. The combustible materials may include a suitable amount of glycerin, potassium permanganate, beeswax, or soy. When combined, these materials react energetically to produce ignition. The combustible materials are isolated within the system until the moment of activation, which prevents accidental combustion. This arrangement ensures safety during storage and transport.

In some embodiments, a catalyst composition is stored within a fourth container positioned within the second container. The catalyst composition may include glycerin and potassium permanganate, which are selected for their ability to ignite without an external flame. The fourth container may include a closure that allows the catalyst composition to remain separated from other components. During activation, the closure is opened so the catalyst composition can be poured into another container. This sequence ensures the chemical reaction occurs only when intended by the user.

The eco-friendly fire starter system may include a third container that is configured to store one or more edible plant-based materials. The third container may be biodegradable and compostable, which aligns with the environmentally responsible nature of the system. The third container allows edible materials to remain isolated from the catalyst composition prior to activation. The separation of materials improves safety and preserves the quality of the edible materials. This structure also contributes to the organized multi-container system.

The activation process may require opening the first container to access the second container. Once the second container is opened, the fourth container can be removed, and its contents poured into the third container. The mixing of the catalyst composition with the edible materials or other combustible materials initiates a chemical reaction. The reaction produces heat sufficient to ignite the containers and other components. This process eliminates the need for an external fire source.

In some embodiments, the chemical reaction produces a sustained flame that burns for at least five minutes. The sustained flame may be sufficient to ignite a fireplace, grill, fire pit, or survival fire. The duration of the flame may vary depending on the specific materials included within the system. Additional plant-based materials or natural waxes may be included to extend the burn time. The ability to sustain combustion without added fuel enhances the reliability of the system.

The first container may be constructed of a biodegradable and compostable material such as hemp. This material selection supports environmentally conscious manufacturing and disposal. The hemp material may also provide durability and moisture resistance for outdoor conditions. The natural composition of the first container may allow it to combust cleanly when ignited. This environmentally friendly construction distinguishes the system from conventional fire starters.

In some embodiments, the first container includes a drawstring positioned at an upper opening. The drawstring allows the user to selectively close and secure the container before or after inserting the second container. The drawstring may be constructed of natural fibers that maintain the eco-friendly character of the system. This closure assists in preventing accidental spillage or component misplacement. The drawstring also supports portability and ease of use.

The system may further include combustible materials such as beeswax or soy wax that enhance burn stability. These materials may be combined with edible materials or plant-based fibers to increase combustion duration. The use of natural waxes supports clean burning with minimal smoke output. The combustible materials contribute to a controlled flame that can be used safely for cooking or heating. This combination improves the system's versatility.

In some embodiments, the edible materials stored within the system have a shelf life of at least sixty years. This extended shelf life makes the system suitable for emergency preparedness, military operations, and long-term storage. The dehydrated nature of the edible materials prevents spoilage and maintains nutritional value. Their longevity ensures the fire starter remains functional and reliable for decades. This characteristic enhances the practical utility of the system.

The system may be configured to ignite even when wet. The catalyst composition may react independently of surrounding moisture levels. The biodegradable containers may also be configured to ignite once the chemical reaction begins. The ability to function in wet conditions is valuable for survival scenarios where dry materials are unavailable. This capability expands the environments in which the system may be used.

The fire starter system may be odorless and produce little to no smoke emissions. This characteristic makes the system suitable for indoor applications such as fireplaces or wood-burning stoves. The absence of toxic chemicals ensures safe use around food and living spaces. The clean burning nature of the materials reduces environmental impact. These features improve user comfort and safety.

The arrangement of the first container, the second container, the third container, and the fourth container creates a nested organizational structure. This structure simplifies use by ensuring each component is accessed in a logical sequence. The user can easily identify and activate the appropriate materials. The nesting also saves storage space and enhances transportability. The orderly design reduces the risk of accidental activation.

In some embodiments, the system may serve additional survival functions beyond fire creation. The edible materials may be consumed to provide nutrients, vitamins, or calories. Certain materials may also be used to purify water or disinfect wounds. These multifunctional features distinguish the system from conventional fire starters. The added capabilities strengthen the system's value in emergency situations.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the fire starter container, according to some embodiments; and

FIG. 2 illustrates a perspective view of the fire starter components, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a combustible fire starter which uses natural, environmentally friendly, and compostable ingredients that do not require and external flame for ignition to occur. The composition of ingredients are capable of burning for at least 5-minutes without the addition of supplemental fuel or other interventions. The fire starter includes a container which enables the containment and protection of the fuel composition therein.

The embodiments provide an eco-friendly and edible product designed to significantly enhance your indoor and outdoor experiences. Crafted with all-natural waxes, dehydrated fruits and seeds, hemp, and non-toxic, biodegradable, combustible plant-based plastic, this multifunctional fire starter is well-suited for grilling, home chimneys, and fire pits. The fire starter is configured for ease-of-use regardless of the user's knowledge of fire making procedures. The fire starter may be ignited without the use of an external fire source.

In some embodiments, the container may be constructed of hemp or a similar material which is formed into a receptacle capable of carrying the fuel composition. The container may also be constructed of an allergen-free material to avoid allergic reactions during use.

In some embodiments, the fuel composition includes bees wax and soy which are capable of combustion for an extended time period. The fuel composition may also include a suitable amount of glycerin and potassium permanganate which is provided with the bees wax and soy.

In some embodiments, the fire starter may include edible components which are placed within the container. The edible components may include fruit, plant materials, and other edible foodstuff. The edible components may be modified based on food allergies, preferences, and dietary needs of the user.

In some embodiments, the plant materials may include olive tree leaves, plant seeds, pinecones, dehydrated citrus, and similar ingredients.

In some embodiments, the fire starter may include various components which may be used to purify water to make the water potable.

In some embodiments, the fire starter may include various components which can be used to clean and/or disinfect wounds.

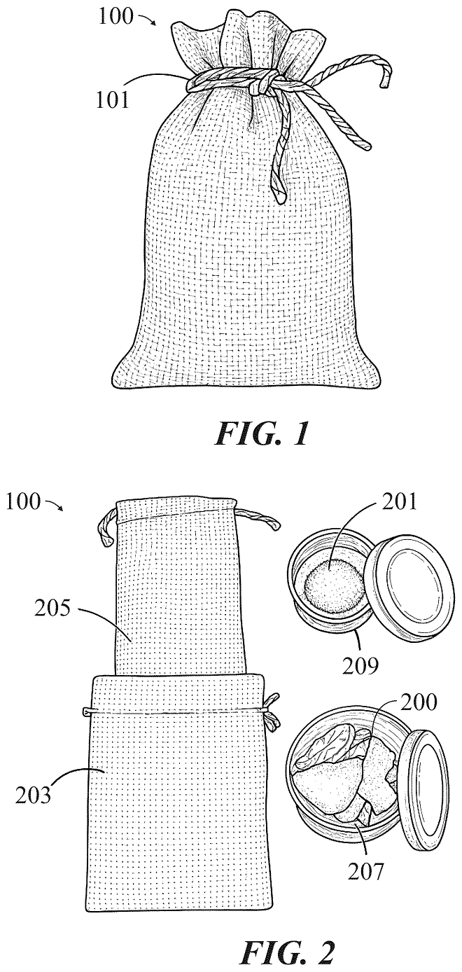

FIG. 1 illustrates the fire starter system 100 including the container 101 having a plurality of combustible, compostable, and/or edible components therein. FIG. 2 illustrates the components of the fire starter including edible components 200, catalysts 201 first container 203, second container 205, third container 207, and fourth container 209.

During use, the container is positioned where the user wishes to ignite a fire. The first container is opened, and the second container is removed from within the first container and then opened. The plant-based, combustible, and compostable third container is also opened. A fourth container is positioned within the second container. The fourth container is poured into the first container to initiate a chemical reaction which produces a flame that is capable of burning for an extended period of time. In such, the chemical reaction results in heat which is sufficient for combusting the fuel composition.

In some embodiments, the fire starter system 100 may be configured to maintain structural integrity during storage, transport, and handling, even when exposed to temperature fluctuations or humidity variations. The materials used in constructing the container 101, including the first container 203 and the second container 205, may be selected to resist tearing, fraying, or degradation before activation. The hemp-based construction may be processed using weaving or pressing techniques that enhance tensile strength without introducing synthetic additives. The interior surfaces of the first container 203 may optionally include a thin plant-based coating that provides additional resistance to moisture. This configuration ensures that the fire starter system 100 remains functional for extended periods of storage, such as in emergency kits or outdoor gear. The materials may also be selected to decompose naturally after combustion, reducing environmental impact.

In some embodiments, the edible components 200 placed within the third container 207 may be dehydrated using low-temperature drying methods that preserve nutrients and structural form. The dehydration process may be selected to ensure that the edible components 200 ignite predictably when combined with the catalysts 201. The edible components 200 may also be cut or shaped into uniform pieces to promote consistent mixing and combustion. In some embodiments, the plant-based materials selected for the edible components 200 may provide varying ignition characteristics based on density or oil content. This allows the fire starter system 100 to be manufactured with differing burn times tailored to user needs. These edible components 200 may be replaced or adjusted depending on allergies, dietary restrictions, or regional availability.

In some embodiments, the catalysts 201 stored within the fourth container 209 may be provided in a pre-measured quantity optimized for producing a sustained flame. The ratio of glycerin to potassium permanganate may be selected to generate a predictable and controlled reaction that avoids excessive heat output. The catalysts 201 may be finely ground or granulated to ensure rapid dissolution or blending when poured onto the materials contained within the first container 203 or third container 207. The fourth container 209 may be designed with structural ridges or indentations that facilitate gripping even when the user is wearing gloves or operating in cold conditions. The fourth container 209 may further include a biodegradable seal that prevents exposure to humidity. This seal may be ruptured or removed prior to activation.

In some embodiments, the first container 203 may include one or more stitching patterns or reinforcements that provide durability without inhibiting combustibility. These reinforcements may be placed around the upper opening, the drawstring channel, or the base of the first container 203. The drawstring may be constructed of hemp fibers twisted or braided to increase strength while remaining fully combustible. In certain embodiments, the drawstring may include a knotting structure that enables rapid opening in emergency situations. The drawstring may also serve as a handle for carrying or hanging the fire starter system 100. These features ensure that the container 101 is both functional and easy to operate.

In some embodiments, the second container 205 may be dimensioned to nest securely within the first container 203 so the components remain stable during transport. The second container 205 may be formed of biodegradable plant-based plastic, molded pulp, hemp fabric, or paper material treated with natural resins. This arrangement permits the second container 205 to be opened without damaging the structure of the first container 203. The second container 205 may also serve as a temporary receptacle during activation by receiving the contents of the fourth container 209. The second container 205 may be configured to collapse or fold after activation to reduce waste volume. These structural features support both usability and sustainability.

In some embodiments, the third container 207 may be shaped to optimize exposure of the edible components 200 to the catalysts 201 when activation occurs. The third container 207 may be shallow, concave, cylindrical, or bowl-shaped depending on the combustion characteristics desired. The interior surface of the third container 207 may include a lightly textured pattern that enhances mixing. When the catalysts 201 are poured into the third container 207, the shape ensures that the edible components 200 are uniformly coated. This results in more reliable ignition and sustained combustion. The third container 207 may also be constructed of plant-based materials that burn cleanly and contribute to the flame.

In some embodiments, activation of the fire starter system 100 may occur using a sequence of steps that can be performed even in low-light or hazardous conditions. The user may first open the first container 203 using the drawstring closure and remove the second container 205. The second container 205 may then be opened to expose the third container 207 and fourth container 209. The user may pour the catalysts 201 from the fourth container 209 into the third container 207 or directly into the first container 203 depending on the configuration. After mixing, the materials may produce an immediate exothermic reaction. This sequence requires minimal dexterity and no additional tools.

In some embodiments, the fire starter system 100 may be packaged with instructions printed directly on the first container 203 or on a biodegradable tag attached to the drawstring. These instructions may illustrate the steps required to activate the system using simple diagrams or text. The instructions may also warn the user to avoid directing the flame toward flammable surroundings. Additional instructions may include guidance on how to use the system for purifying water or cleaning wounds. This instructional material may decompose naturally after disposal. These features support both safety and convenience.

In some embodiments, the fire starter system 100 may be adapted for various climates or environmental conditions. For example, in cold climates, the materials may be formed with lower moisture content to accelerate ignition. In humid regions, the containers may incorporate moisture-resistant treatments derived from natural waxes or oils. The system may also be produced in varying sizes to accommodate different fire-building needs, such as small campfires or large fireplace ignitions. Such variations allow the system to be tailored to geographic and situational use cases. These adaptations make the system versatile for a wide range of users.

In some embodiments, the fire starter system 100 may be manufactured through an assembly process that prioritizes material efficiency and quality control. The edible components 200 may be measured and placed within the third container 207 by automated or manual processes. The catalysts 201 may be sealed in the fourth container 209 prior to placement within the second container 205. Once assembled, the components may be inserted into the first container 203 and secured. Each unit may undergo inspection to ensure the catalyst composition remains dry and the edible components remain intact. This manufacturing approach promotes consistent performance.

In some embodiments, the fire starter system 100 may be included within larger emergency or survival kits. The compact size and long shelf life allow the system to be stored alongside tools, medical supplies, or food rations. The edible components 200 may serve as supplementary nutrition, while the catalysts 201 provide a dependable means of fire generation. The system may also be used in recreational settings such as camping or hiking. Its multifunctional capabilities reduce the number of separate tools a user must carry. This integration enhances the system's overall utility.

In some embodiments, the fire starter system 100 may be used to teach fire safety or survival skills. The predictable ignition characteristics allow instructors to demonstrate fire-building techniques without reliance on open flame tools. The environmentally friendly nature of the materials supports educational programs focused on sustainability. Students may observe the chemical reaction and learn about decomposition, plant-based materials, and clean combustion. The system's simplicity reduces the risk of user error. These features make the system suitable for both practical and instructional environments.

In some embodiments, a fuel composition contained within the fire starter system 100 may include a mixture of natural waxes, oxidizing agents, liquid fuels, and plant-based materials formulated to provide a predictable and sustained flame. The fuel composition may include from about 20 percent to about 60 percent by weight of one or more natural waxes, such as bees wax and soy wax, which act as a primary combustible matrix. The fuel composition may further include from about 5 percent to about 25 percent by weight of an oxidizing agent such as potassium permanganate. In some embodiments, the fuel composition may also include from about 5 percent to about 20 percent by weight of a liquid fuel such as glycerin. The remaining balance of the fuel composition, which may be from about 10 percent to about 50 percent by weight, may be provided by edible plant-based materials, dehydrated fruits, seeds, or hemp fibers. These ranges may be adjusted depending on the desired burn time, flame height, and environmental conditions in which the fire starter system 100 is intended to be used. Within these ranges, the fuel composition remains capable of ignition without an external flame while still burning in a controlled manner.

In certain embodiments, the natural wax portion of the fuel composition may be divided between bees wax and soy wax to balance hardness, melting point, and combustion characteristics. For example, the fuel composition may include from about 10 percent to about 40 percent by weight of bees wax and from about 10 percent to about 30 percent by weight of soy wax. A higher proportion of bees wax may be selected to increase structural rigidity and extend burn time, while a higher proportion of soy wax may be selected to promote easier initial melting and improved wicking around the edible components 200. In some embodiments, the ratio of bees wax to soy wax may range from about 3:1 to about 1:3 by weight. These ranges permit manufacturers to tailor the fire starter system 100 for specific applications, such as shorter, hotter burns or longer, steadier burns. The natural waxes may also act as binders that physically immobilize other components within the container 101. This immobilization may help prevent component segregation during shipment and handling.

In some embodiments, the oxidizing agent portion of the catalysts 201 may be formulated to fall within ranges that provide reliable ignition without excessive or unsafe reaction rates. The potassium permanganate content of the catalysts 201 may range from about 5 percent to about 20 percent by weight of the total fuel composition contained within the container 101. When the catalysts 201 are stored separately in the fourth container 209, the potassium permanganate may constitute from about 40 percent to about 90 percent by weight of the contents of the fourth container 209. In such arrangements, the remaining portion of the contents of the fourth container 209 may include inert fillers, flow aids, or other solid materials that assist in controlled pouring. These ranges allow the oxidizing agent to be present in sufficient quantity to react with the glycerin while minimizing the risk of overly vigorous reactions. By maintaining the oxidizing agent within these ranges, the fire starter system 100 can be configured to ignite predictably even after long-term storage. The specific values within the range may be selected according to regulatory, safety, or manufacturing constraints.

In some embodiments, the liquid fuel portion of the catalysts 201 may be provided by glycerin in an amount that is sufficient to wet the oxidizing agent and initiate the exothermic reaction. When considered relative to the entire fuel composition contained within the fire starter system 100, the glycerin may be present in an amount from about 5 percent to about 15 percent by weight. When considered relative to the combined contents of the fourth container 209 and the materials with which it is intended to react, the glycerin may be present in an amount from about 10 percent to about 40 percent by weight. These ranges allow the glycerin to be supplied in sufficient quantity to sustain the reaction without leaving an excessive unreacted liquid residue. The viscosity of the glycerin may be selected to promote controlled spreading over the edible components 200 and wax matrix. Within these ranges, the glycerin may also assist in temporarily binding loose granules or fragments so the reaction proceeds uniformly. Variations in glycerin content may be employed to fine-tune ignition delay and flame development.

In some embodiments, the edible components 200 may constitute a significant fraction of the fuel composition while still preserving their ability to be safely consumed prior to activation if needed in an emergency. The edible components 200 may represent from about 10 percent to about 50 percent by weight of the overall composition contained within the first container 203 or the third container 207. In certain embodiments, dehydrated citrus slices, seeds, or plant materials may constitute from about 15 percent to about 35 percent by weight of the total composition. These ranges allow the edible components 200 to meaningfully contribute to combustion by wicking and vaporizing oils while also delivering caloric value. In some embodiments, the edible components 200 may be coated with a thin layer of wax that represents from about 1 percent to about 10 percent by weight of the total composition to promote ignition without compromising edibility prior to activation. The proportion of edible components 200 may be adjusted so the fire starter system 100 can be marketed as either a high-calorie survival aid or a more conventional fire starter product. The ranges described herein permit such flexibility without deviating from the core inventive concept.

In some embodiments, the plant-based polymer or plastic forming portions of the containers or third container 207 may be present in relatively small amounts that nonetheless contribute to structural integrity and combustion behavior. For example, a molded plant-based plastic cup or liner used to hold the edible components 200 may constitute from about 2 percent to about 15 percent by weight of the materials contained within the first container 203. This plant-based plastic may be formulated to soften and deform at temperatures below the combustion temperature of the waxes and edible components 200, thereby creating additional surface area for the flame. In other embodiments, finely divided plant-based plastic fragments may be dispersed throughout the wax matrix in quantities ranging from about 1 percent to about 8 percent by weight of the fuel composition. These fragments may melt and vaporize, contributing to steady flame propagation without generating significant smoke. The amount of plant-based plastic may be selected so the entire system remains compostable after use. These ranges ensure that the structural benefits of the plant-based plastic are achieved without overwhelming the natural components.

In some embodiments, the total mass of the fuel composition contained within an individual fire starter system 100 may be tailored to different use cases. A compact unit intended for personal survival kits may contain from about 5 grams to about 25 grams of total combustible material. A larger unit intended for home fireplaces or grills may contain from about 20 grams to about 100 grams of combustible material. Within each size category, the relative percentages of natural waxes, edible components 200, oxidizing agents, and liquid fuels may remain within the ranges described herein. The mass of the composition may be selected so the fire starter system 100 provides a burn time ranging from about five minutes to about twenty-five minutes. In some embodiments, multiple units may be bundled together to allow a user to easily scale the total heat output. These size and mass ranges give manufacturers flexibility while maintaining consistent performance.

In some embodiments, the catalysts 201 may be subdivided into separate portions so that the user may select a desired reaction intensity. For example, the fourth container 209 may include two or more internal compartments, each holding from about 1 gram to about 5 grams of oxidizing agent or liquid fuel. A user may choose to open and combine only one portion to achieve a shorter or less intense burn, or may choose to combine all portions for maximum flame duration. The internal compartments may collectively contain the oxidizing agent and liquid fuel in amounts within the ranges previously described. This modular approach allows the fire starter system 100 to be tailored in real time without requiring separate products. Such arrangements remain within the scope of the disclosed ranges yet provide additional control over combustion behavior. The use of multiple smaller portions may also reduce the risk associated with accidental activation.

In some embodiments, the combustible components may further include minor additives that remain within narrow ranges so as not to detract from the natural and edible character of the product. For example, natural fibers such as shredded hemp, jute, or cotton may be included at levels from about 1 percent to about 10 percent by weight of the fuel composition as wicking aids. Natural essential oils or plant resins may be included in amounts from about 0.5 percent to about 5 percent by weight to assist with ignition and improve the sensory characteristics of the flame, such as smell or visible brightness. These additives may be selected from food-grade or generally regarded as safe materials. The combined amount of such minor additives may remain below about 15 percent by weight of the overall composition so the principal components remain the waxes, edible materials, oxidizing agents, and liquid fuel. Within these ranges, the additives can enhance performance while preserving safety. The specific choice of additives may vary based on regional availability or branding considerations.

In some embodiments, the ratios of the materials contained in the first container 203, second container 205, third container 207, and fourth container 209 may be expressed on a per-unit basis to facilitate manufacturing and quality control. For instance, a representative unit may include from about 10 grams to about 40 grams of material in the first container 203, of which from about 5 grams to about 25 grams represent the wax matrix and edible components 200, and from about 1 gram to about 5 grams represent plant-based plastic structures. The second container 205 may primarily provide separation and may add less than about 5 grams of additional material. The fourth container 209 may include from about 1 gram to about 10 grams of catalysts 201, with the relative amounts of oxidizing agent and liquid fuel selected within the ranges described above. These per-unit values may be scaled up or down while preserving the same proportional relationships. By expressing the composition in both percentage ranges and representative mass ranges, the disclosure supports a broad variety of commercial implementations without departing from the inventive concepts.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An eco-friendly fire starter system, comprising:
a first container;
a second container configured to be removably stored within an interior of the first container;
at least one plant-based material stored in a third container, the third container configured to be stored within the first container; and
a fourth container containing two or more combustible materials utilized to catalyze a chemical reaction to combust one or more combustible components.

2. The eco-friendly fire starter system of claim 1, wherein the first container and the second container are constructed of hemp.

3. The eco-friendly fire starter system of claim 1, wherein the at least one plant-based material is provided as an edible product to provide calories in the event of an emergency.

4. The eco-friendly fire starter system of claim 1, wherein the at least one plant-based material includes at least one of the following: a dehydrated citrus, a seed, and a vegetable.

5. The eco-friendly fire starter system of claim 1, first container includes a first draw string position to open and close a first opening of the first container.

6. The eco-friendly fire starter system of claim 1, second container includes a second draw string position to open and close a second opening of the second container.

7. The eco-friendly fire starter system of claim 1, wherein the two or more combustible materials include at least two of the following: a suitable amount of glycerin, a suitable amount of potassium permanganate, a suitable amount of bees wax, and a suitable amount of soy.

8. The eco-friendly fire starter system of claim 1, wherein the chemical reaction results in a sustained combustion time of at least 5-minutes.

9. An eco-friendly fire starter system, comprising:
a first container;
a second container configured to be removably stored within an interior of the first container;
at least two combustible materials used to catalyze a chemical reaction to combust the first container and the second container; and
one or more edible materials stored within one of the first container or the second container.

10. The eco-friendly fire starter system of claim 9, wherein the first container and the second container are constructed of a biodegradable and a compostable material.

11. The eco-friendly fire starter system of claim 10, wherein the first container and the second container are constructed of hemp.

12. The eco-friendly fire starter system of claim 9, wherein one or more edible materials are plant-based.

13. The eco-friendly fire starter system of claim 9, wherein the one or more edible materials include at least one of the following: a dehydrated citrus, a seed, and a vegetable.

14. The eco-friendly fire starter system of claim 9, first container includes a first draw string position to open and close a first opening of the first container.

15. The eco-friendly fire starter system of claim 9, second container includes a second draw string position to open and close a second opening of the second container.

16. The eco-friendly fire starter system of claim 9, wherein the at least two combustible materials include at least two of the following: a suitable amount of glycerin, a suitable amount of potassium permanganate, a suitable amount of bees wax, and a suitable amount of soy.

17. The eco-friendly fire starter system of claim 1, wherein the chemical reaction results in a sustained combustion time of at least 5-minutes.

18. An eco-friendly fire starter system, comprising:
a first container constructed of hemp and configured to contain a plurality of plant-based materials;
a second container removably positioned within an interior of the first container, the second container comprising a biodegradable and compostable material;
a catalyst composition comprising glycerin and potassium permanganate stored within a fourth container positioned within the second container;
a third container disposed within the first container and configured to store one or more edible plant-based materials including at least one of a dehydrated citrus and a seed; and
wherein activation of the catalyst composition comprises opening the fourth container and pouring the catalyst composition directly into the third container to initiate a chemical reaction sufficient to combust at least a portion of the first container and the second container and produce a sustained flame.

19. The eco-friendly fire starter system of claim 18, wherein the first container further comprises a drawstring positioned at an upper opening of the first container and configured to selectively close the first container prior to activation of the catalyst composition.

20. The eco-friendly fire starter system of claim 3, wherein the sustained flame produced by activation of the catalyst composition burns for at least five minutes without the addition of supplemental fuel.
